(19) United States
(12) Patent Application Publication
(10) Pub. No.: US 2025/0187603 A1
(43) Pub. Date: Jun. 12, 2025

(54) TRAVEL CONTROL DEVICE FOR VEHICLE

(71) Applicant: MITSUBISHI JIDOSHA KOGYO KABUSHIKI KAISHA, Tokyo (JP)

(72) Inventors: Ryosuke KOGA, Tokyo (JP); Ryo HACHISUKA, Tokyo (JP)

(73) Assignee: MITSUBISHI JIDOSHA KOGYO KABUSHIKI KAISHA, Tokyo (JP)

(21) Appl. No.: 18/838,827

(22) PCT Filed: Mar. 17, 2023
(86) PCT No.: PCT/JP2023/010602

§ 371 Date: Aug. 15, 2024

(30) Foreign Application Priority Data
Mar. 24, 2022 (JP) 2022-047826

(51) Int. Cl. B60W 30/18; B60W 10/08; B60W 10/184; B60W 50/08

(52) U.S. Cl. CPC B60W 30/18172; B60W 10/08; B60W 10/184; B60W 50/087; B60W 2520/14; B60W 2720/14; B60W 2720/26; B60W 2720/28

(57) ABSTRACT

A traction control device 50 for a vehicle including a front motor and a rear motor which drive wheels and a braking device provided to each of front and rear wheels on left and right includes a hybrid control unit 20 that calculates a requested driving force of the vehicle based on a driver request and a vehicle behavior and a control units 10 and 12 that controls the motors and the braking devices based on the requested driving force. The hybrid control unit 20 includes a reference wheel speed calculating part 52 that calculates a target reference wheel speed for each of the front and rear wheels on the left and right, and a target slip rate calculating/distributing part 54 that calculates a target slip rate of the wheels which is set relative to the target reference wheel speed. The control units 10 and 12 include a slip rate control part 62 that calculates an actual slip rate of the wheels and also controls each of the motors and the braking devices in a manner that the actual slip rate is controlled to be the target slip rate.

### TECHNICAL FIELD

The present invention relates to a travel control device for a vehicle.

### BACKGROUND ART

In recent years, in order to prevent vehicle skidding and improve turning performance, a braking and driving device has been developed which controls a drive torque or a brake torque of a vehicle to be different values for left and right wheels (running wheels).

For example, Patent Document 1 describes, as a prior art technique, a control device that drives and controls each of electric motors for four wheels such that a turning acceleration of a vehicle body which is detected by a yaw rate sensor can gain a requested turning acceleration calculated based on a steering angle or the like in a vehicle that independently drives the four wheels of the vehicle by the electric motors. Patent Document 1 also proposes a technique, in a vehicle that drives left and right front wheels of a vehicle via a differential by a first electric motor and drives left and right rear wheels of the vehicle via the differential by a second electric motor, for driving and controlling the first electric motor and the second electric motor and also for operating and controlling braking devices of the wheels to control a turning acceleration of the vehicle.

### PRIOR ART DOCUMENT

### Patent Document

Patent Document 1: Japanese Patent Laid-Open No. 2011-254590

### SUMMARY OF THE INVENTION

### Problems to be Solved by the Invention

With regard to a vehicle of Patent Document 1, in the vehicle configured as described above, a main control unit (CPU) performs various calculations such as a slip rate and calculates a control amount of each motor and a pressure adjustment amount of the braking device.

However, even when electrically-driven motors are used, a control delay in the control unit may occur, and a driving control device capable of performing more responsive slip rate control (traction control) has been demanded.

The present invention has been made in view of the above problem, and an object of the present invention is to provide a travel control device for a vehicle which is capable of performing highly responsive traction control.

### Means for Solving the Problems

In order to achieve the above object, a travel control device for a vehicle of the present invention is a travel control device for a vehicle, the vehicle including driving means for driving front and rear wheels on left and right and braking means for independently braking the front and rear wheels on the left and right and being capable of driving and braking the front and rear wheels on the left and right by the driving means and the braking means, the travel control device including a main control unit that calculates a requested driving force of the vehicle based on a driver request and a vehicle behavior, and a sub control unit which is provided to each of the driving means and the control means downstream the main control unit and which controls each of the driving means and the control means based on the requested driving force, in which the main control unit includes a target reference wheel speed calculating part that calculates a target rotation speed set as a reference of the wheels, and a target slip rate calculating part that calculates a target slip rate of the wheels which is set relative to the target reference wheel speed, the main control unit calculates the requested driving force based on the target slip rate, and the sub control unit includes an actual slip rate calculating part that calculates an actual slip rate of the wheels, and a slip rate control part that corrects the requested driving force in a manner that the actual slip rate turns to the target slip rate to control the driving means or the braking means.

With this configuration, the target slip rate of the wheels is calculated in the main control unit, and on the other hand, the driving means or the braking means is controlled to control the actual slip rate to be the target slip rate in the sub control unit which is provided to each of the driving means and the braking means downstream the main control unit and which has a smaller delay due to communication or the like than a delay of the main control unit, so that it is possible to control the actual slip rate to be the target slip rate for each of the wheels with good responsiveness.

Preferably, the target reference wheel speed calculating part may calculate the target reference wheel speed for each of the wheels, and the target slip rate calculating part may calculate the target slip rate for each of the wheels.

With this configuration, the target reference wheel speed is calculated for each of the wheels, and the target slip rate is calculated for each of the wheels, so that the wheel speed and the target slip rate can be accurately controlled for each of the wheels. Therefore, it becomes possible to precisely control the traction of each wheel and accurately control the vehicle behavior.

Preferably, the target reference wheel speed calculating part may calculate the target reference wheel speed to be set as a value common to the front and rear wheels on the left and right, and the target slip rate calculating part may calculate the target slip rate for each of the wheels.

With this configuration, the target reference wheel speed is calculated to be set as the value common to the front and rear wheels on the left and right, so that calculation load of the target reference wheel speed in the main control unit can be reduced. In addition, the target slip rate is calculated for each of the wheels, so that it becomes possible to control the target slip rate for each of the wheels and control the traction of each wheel.

Preferably, the target reference wheel speed calculating part may calculate the target reference wheel speed for each of the wheels, and the target slip rate calculating part may calculate the target slip rate to be set as a value common to the front and rear wheels on the left and right.

With this configuration, the target slip rate is calculated to be set as the value common to the front and rear wheels on the left and right, calculation load of the target slip rate in the main control unit can be reduced. In addition, the target reference wheel speed is calculated for each of the wheels, so that it becomes possible to control the target reference wheel speed for each of the wheels and control the traction of each wheel.

Preferably, the travel control device for the vehicle further includes a target yaw rate calculating part that calculates a target yaw rate of the vehicle based on at least a steering angle of the vehicle, and a yaw rate detecting part that detects an actual yaw rate of the vehicle, and the target slip rate calculating part may change the target slip rate for each of the wheels based on the target yaw rate or a difference between the target yaw rate and the actual yaw rate.

With this configuration, the target slip rate changes according to the target yaw rate or the difference between the target yaw rate and the actual yaw rate, that is, according to a turning attitude of the vehicle, so that it becomes possible to control turning promotion and turning suppression of the vehicle according to the steering angle.

Preferably, the travel control device for the vehicle further includes a driving force estimating part that estimates a total driving force of the vehicle, and the target slip rate calculating part may change the target slip rate for each of the wheels based on the requested driving force or a difference between the requested driving force and the total driving force.

With this configuration, the target slip rate changes according to the requested driving force of the vehicle or the difference between the requested driving force and the total driving force, that is, according to a road surface condition, so that it becomes possible to perform control in a manner that the total driving force of the vehicle corresponding to an accelerator pedal position can secure the requested driving force.

Preferably, the driving means and the braking means include a first electric motor that drives the front wheels of the vehicle and a second electric motor that drives the rear wheels of the vehicle, and a braking device which is provided to each of the front and rear wheels on the left and right of the vehicle and which is capable of applying a mutually different braking force to each of the wheels.

With this configuration, in the vehicle including the two travelling electric motors and the braking devices capable of individually braking the respective wheels in the vehicle, the actual slip rate can be swiftly controlled to be the target slip rate for each of the wheels, and travelling performance of the vehicle can be improved.

### Advantageous Effects of the Invention

The travel control device for the vehicle of the present invention can swiftly control the actual slip rate to be the target slip rate for each of the wheels, so that it becomes possible to perform the responsive traction control, and the travelling performance of the vehicle can be improved.

### BRIEF DESCRIPTION OF THE DRAWINGS

FIG. 1 is a schematic configuration diagram of a plug-in hybrid vehicle including a traction control device according to an embodiment of the present invention.

FIG. 2 is a block diagram illustrating a schematic configuration of the traction control device according to the present embodiment.

FIG. 3 is a data flow diagram illustrating a calculation procedure of a target slip rate.

### MODE FOR CARRYING OUT THE INVENTION

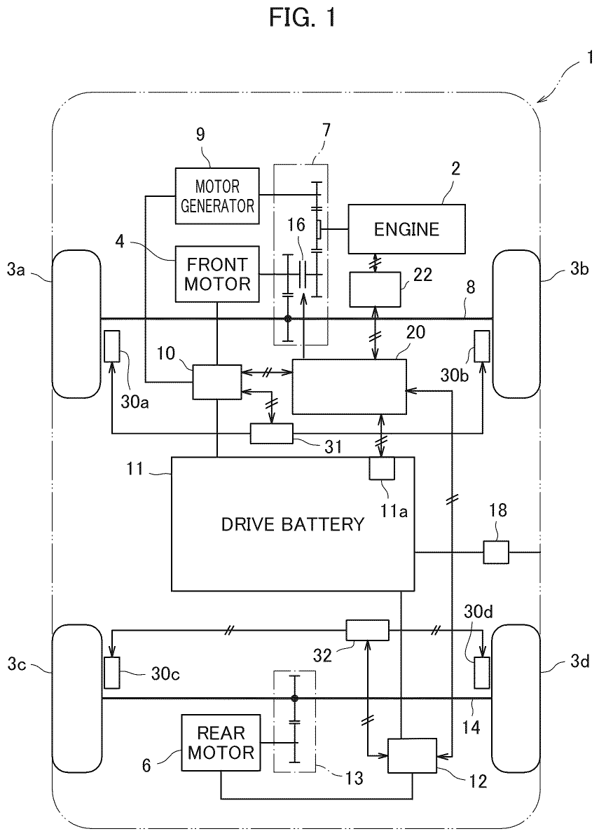

FIG. 1 is a schematic configuration diagram of a plug-in hybrid vehicle (hereinafter, referred to as a vehicle 1) including a driving control device according to a first embodiment of the present invention.

The vehicle 1 according to the first embodiment in which a travel control device of the present invention is adopted is a four-wheel drive vehicle which can travel by driving front wheels 3a and 3b (running wheels) by an output of an engine 2, and which includes an electrically-driven front motor 4 (first electric motor, driving means) which drives the front wheels 3a and 3b and an electrically-driven rear motor 6 (second electric motor, driving means) which drives rear wheels 3c and 3d (running wheels).

The engine 2 can drive a drive shaft 8 of the front wheels 3 via a front transaxle 7, and can also drive a motor generator 9 via the front transaxle 7 to generate electric power. In addition, the engine 2 and the front wheels 3a and 3b are connected via a clutch 16 arranged in the front transaxle 7.

The front motor 4 is driven by being supplied with high voltage electric power from a drive battery 11 mounted to the vehicle 1 and the motor generator 9 via a front control unit 10 (sub control unit), and drives the drive shaft 8 of the front wheels 3a and 3b via the front transaxle 7.

The rear motor 6 is driven by being supplied with high voltage electric power from the drive battery 11 via a rear control unit 12 (sub control unit), and drives a drive shaft 14 of the rear wheels 3c and 3d via a rear transaxle 13.

The electric power generated by the motor generator 9 can charge the drive battery 11 via the front control unit 10, and also the front motor 4 and the rear motor 6 can be supplied with the electric power.

The drive battery 11 is formed by a secondary battery such as a lithium-ion battery, and has a battery module which is not illustrated in the drawing which is formed by of a plurality of battery cells combined together. In addition, the drive battery 11 includes a state-of-charge detecting part 11a that detects a state of charge SOC of the drive battery 11.

The front control unit 10 has a function of controlling a drive torque and a regenerative brake torque of the front motor 4 based on a control signal from a hybrid control unit 20 (main control unit) mounted to the vehicle 1, and also controlling an amount of electric power generation and an output of the motor generator 9.

The rear control unit 12 has a function of controlling a drive torque and a regenerative brake torque of the rear motor 6 based on a control signal from the hybrid control unit 20.

An engine control unit 22 is a control device of the engine 2, and includes an input/output device, a storage device (such as a ROM, a RAM, or a nonvolatile RAM), a central processing unit (CPU), a timer, and the like. The engine control unit 22 controls, based on a control signal (request output) from the hybrid control unit 20, a fuel injection amount and a fuel injection timing, an intake air amount, and the like in the engine 2 to drive and control the engine 2.

The vehicle 1 also includes a fuel tank storing fuel which is not illustrated in the drawing and from which the fuel is to be supplied to the engine 2, and a battery charger 18 that charges the drive battery 11 by an external power source.

The hybrid control unit 20 is a control device configured to perform comprehensive control of the vehicle 1, and includes an input/output device, a storage device (such as a ROM, a RAM, or a nonvolatile RAM), a central processing unit (CPU), a timer, and the like.

The front control unit 10, the rear control unit 12, and the engine control unit 22 are connected to an input side of the hybrid control unit 20, and detection and operative information is input from these devices.

On the other hand, the front control unit 10, the rear control unit 12, the engine control unit 22, and the clutch 16 of the front transaxle 7 are connected to an output side of the hybrid control unit 20.

The hybrid control unit 20 then calculates a vehicle requested output necessary for travelling drive of the vehicle 1 based on various detection amounts such as an accelerator operation information level of the vehicle 1 and various operative information, and sends control signals to the engine control unit 22, the front control unit 10, and the rear control unit 12 to control switching of travelling modes (an EV mode, a series mode, and a parallel mode), outputs of the engine 2, the front motor 4, and the rear motor 6, electric power generation and output of the motor generator 9, and engagement and disengagement of the clutch 16 in the front transaxle 7.

In the EV mode, the engine 2 is stopped, and the front motor 4 and the rear motor 6 are driven for travelling using electric power supplied from the drive battery 11.

In the series mode, the clutch 16 in the front transaxle 7 is disengaged to operate the motor generator 9 by the engine 2. The front motor 4 and the rear motor 6 are then driven for travelling using electric power generated by the motor generator 9 and electric power supplied from the drive battery 11. In addition, in the series mode, a rotation speed of the engine 2 is set to an efficient value, and electric power generated by an excess output is supplied to the drive battery 11 to charge the drive battery 11.

In the parallel mode, the clutch 16 in the front transaxle 7 is engaged to mechanically transmit motive power from the engine 2 via the front transaxle 7 to drive the front wheels 3a and 3b. In addition, the front motor 4 and the rear motor 6 are driven by electric power generated upon operation of the motor generator 9 by the engine 2 and electric power supplied from the drive battery 11 for travelling.

The hybrid control unit 20 sets the travelling mode as the parallel mode in a region where efficiency of the engine 2 is good as in, for example, a high speed region. In regions except for the parallel mode, that is, medium and low speed regions, the travelling mode is switched between the EV mode and the series mode based on the state of charge SOC (amount of charge) of the drive battery 11.

The respective wheels 3a to 3d of the vehicle 1 include braking devices 30a, 30b, 30c, and 30d (braking means), each of which applies a brake torque to the wheel. The front wheel braking devices 30a and 30b are controlled by a front brake control unit 31 (sub control unit), and the rear wheel braking devices 30c and 30d are controlled by a rear brake control unit 32 (sub control unit), so that a configuration is established in which the brake torque can be independently controlled for each of the wheels 3a to 3d. The front brake control unit 31 and the rear brake control unit 32 are connected to the hybrid control unit 20 so as to be communicable with each other. It is noted that the front brake control unit 31 may be connected to the hybrid control unit 20 via the front control unit 10 and the rear brake control unit 32 may be connected to the hybrid control unit 20 via the rear control unit 12 so as to be communicable with each other. The front brake control unit 31 and the rear brake control unit 32 operate and control each of the braking devices 30a to 30d based on operation signals or the like of a braking pedal from a braking pedal sensor which is not illustrated in the drawing.

Any of the front control unit 10, the rear control unit 12, the front brake control unit 31, and the rear brake control unit 32 includes an input/output device, a storage device (such as a ROM, a RAM, or a nonvolatile RAM), a central processing unit (CPU), a timer, and the like. These control units 10, 12, 31, and 32 use devices with a processing speed faster than that of the hybrid control unit 20.

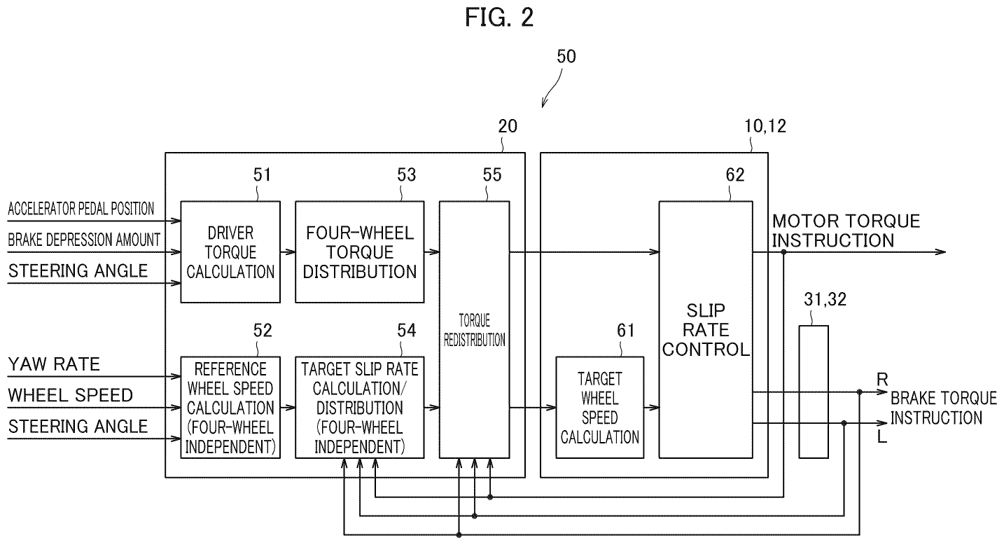

FIG. 2 is a block diagram illustrating a schematic configuration of a traction control device 50 (travel control device) according to an embodiment according to the present invention.

The traction control device 50 according to the embodiment of the present invention includes the hybrid control unit 20, a motor control unit (front control unit 10, rear control unit 12), and a brake control unit (front brake control unit 31, rear brake control unit 32). It is noted that FIG. 2 illustrates one each of the motor control units 10 and 12 and the brake control units 31 and 32, but the vehicle 1 according to the present embodiment includes two pairs of those for the front wheels and the rear wheels.

The hybrid control unit 20 includes a driver torque calculating part 51, a reference wheel speed calculating part 52 (target reference wheel speed calculating part), a four-wheel torque distributing part 53, a target slip rate calculating/distributing part 54 (target slip rate calculating part), and a torque redistributing part 55.

The driver torque calculating part 51 inputs an accelerator pedal position, a brake depression amount, and a steering angle of the vehicle 1 to calculate a travelling drive torque of the entire vehicle which is requested by a driver.

The reference wheel speed calculating part 52 inputs a detection value related to a turning attitude of the vehicle such as a yaw rate, a wheel speed, or a steering angle to calculate a reference speed (target reference wheel speed) for each of the four wheels. It is noted that the yaw rate is detected by a yaw rate sensor 74 (yaw rate detecting part) provided to the vehicle 1.

The four-wheel torque distributing part 53 distributes the travelling drive torque of the entire vehicle which is calculated in the driver torque calculating part 51 to each wheel and calculates a drive torque of each of the wheels 3a to 3d. It is noted that the distribution of the drive torque to each of the wheels 3a to 3d is performed, for example, based on travelling operation information of the vehicle such as the accelerator pedal position, the brake depression amount, or the steering angle of the vehicle 1, vehicle speed information, or the like.

The target slip rate calculating/distributing part 54 calculates a target slip rate based on the reference wheel speed of each of the wheels 3a to 3d which is calculated in the reference wheel speed calculating part 52 and an actual wheel speed. It is noted that the actual wheel speed may be detected, for example, by a rotation speed sensor provided to each of the wheels 3a to 3d, the drive shafts 8 and 14, and the like.

The torque redistributing part 55 corrects and redistributes, based on the target slip rate for each of the wheels 3a to 3d which is calculated in the target slip rate calculating/distributing part 54 and the actual wheel speed, the drive torque of each of the wheels 3a to 3d which is calculated in the four-wheel torque distributing part 53. At this time, the torque is distributed such that the slip rates of the four wheels is evened out without changing a driver requested torque.

The motor control units 10 and 12 have a target wheel speed calculating part 61 and a slip rate control part 62 (actual slip rate calculating part, slip rate control part).

The target wheel speed calculating part 61 calculates a target wheel speed of each of the wheels 3a to 3d based on the reference wheel speed which is calculated in the reference wheel speed calculating part 52 and the target slip rate which is calculated in the target slip rate calculating/distributing part 54.

The slip rate control part 62 calculates an actual slip rate to be calculated from the target wheel speed calculated in the target wheel speed calculating part 61 and the actual wheel speed, corrects and outputs a motor torque instruction amount such that the actual slip rate becomes the target slip rate calculated in the target slip rate calculating/distributing part 54, and also outputs the brake torque instruction amount of the braking devices 30a to 30d to the brake control units 31 and 32.

It is noted that the slip rate control part 62 feeds back a correction amount of the motor torque instruction amount to the hybrid control unit 20.

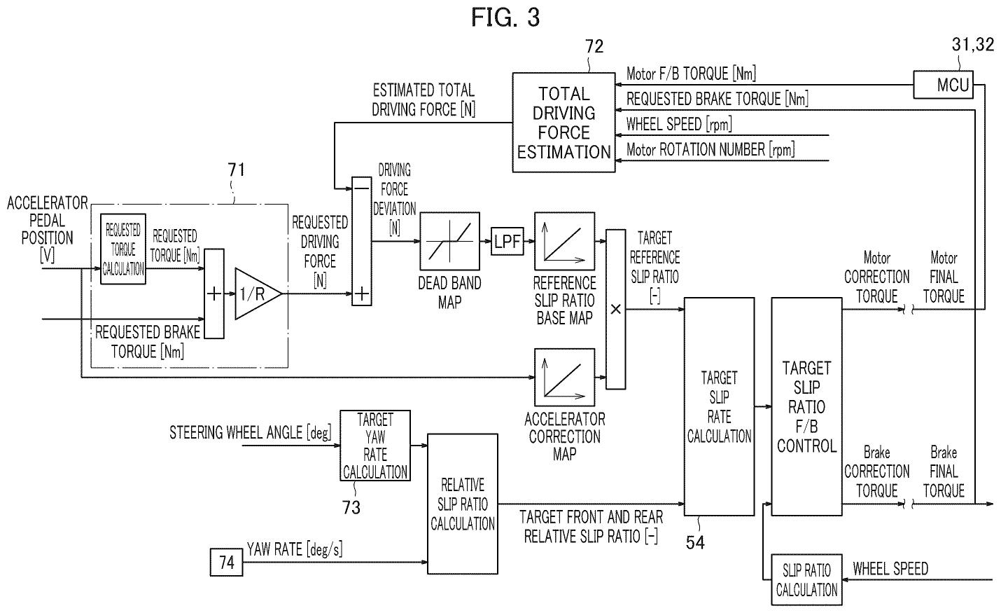

The calculation of the target slip rate in the hybrid control unit 20 will be described in detail with reference to FIG. 3.

FIG. 3 is a data flow diagram illustrating a calculation procedure of the target slip rate.

As illustrated in FIG. 3, in the hybrid control unit 20, a requested torque is calculated from the accelerator pedal position, and a requested brake torque calculated from the brake depression amount or the like is added to calculate a requested driving force (requested driving force calculating part 71).

The requested driving force is added with an estimated total driving force which will be described below, and in order to suppress chattering, a target reference slip ratio (rate) is calculated from a value adjusted via a dead band map and a lowpass filter by using a reference slip base map.

On the other hand, the accelerator pedal position is corrected by using an accelerator correction map, and the accelerator pedal position after the correction is multiplied by the above reference slip ratio to calculate the target reference slip ratio.

In addition, a target yaw rate is calculated from a detection value of a steering wheel angle (target yaw rate calculating part 73), and a target front and rear relative slip ratio is calculated based on the target yaw rate and a detection value of the yaw rate.

A target slip ratio is then calculated based on the target reference slip ratio and the target front and rear relative slip ratio (target slip rate calculating/distributing part 54). The calculated target slip ratio is sent to the motor control units 10 and 12.

In the motor control units 10 and 12, an actual slip ratio is calculated from the actual wheel speed, and a motor correction torque and a brake correction torque are calculated such that this actual slip ratio becomes the target slip ratio.

Then, a motor final torque is output to the motor control units 10 and 12 from the hybrid control unit 20 based on the motor correction torque, and a brake final torque is output to the brake control units 31 and 32 from the hybrid control unit 20 based on the brake correction torque.

A requested motor torque from the hybrid control unit 20 is corrected by the motor correction torque calculated in each of the motor control units 10 and 12, and the front motor 4 and the rear motor 6 output the drive torque as the motor final torque. In addition, with regard to braking, the requested brake torque from the hybrid control unit 20 and a request of the brake correction torque calculated in the motor control units 10 and 12 are output to each of the brake control units 31 and 32, and torque correction is performed in the brake control units 31 and 32 to output the brake torque as the brake final torque.

Furthermore, based on a motor feedback torque after the feedback control in the motor control units 10 and 12, the brake final torque in the brake control units 31 and 32, the actual wheel speed, and the actual motor rotation speed, the estimated total driving force of the vehicle 1 is calculated in the hybrid control unit 20 (total driving force estimating part 72 (driving force estimating part)). This estimated total driving force is used for the addition with the requested driving force in a preceding stage of the dead band map described above.

As described above, according to the present embodiment, the drive torque and the brake torque of the front and rear wheels 3a to 3d on the left and right are controlled by the torque control on the front motor 4 and the rear motor 6 for travelling drive and the brake torque control on the braking devices 30a to 30d to perform the traction control on each of the wheels 3a to 3d.

According to the present embodiment, in the hybrid control unit 20, the drive torque of each of the wheels 3a to 3d is calculated, but the control on the slip rate of each of the wheels 3a to 3d, in more detail, the feedback control of the wheel speed is executed in the motor control units 10 and 12 and the brake control units 31 and 32.

As described above, the motor control units 10 and 12 and the brake control units 31 and 32 use devices with higher processing performance than that of the hybrid control unit 20 and further have a smaller time lag (such as a communication delay) until the final torque output than that of the hybrid control unit 20. In this manner, by performing the control on the slip rate by using the units with the high processing performance and the small communication delay, travelling performance of the vehicle 1 can be improved by using the units which are highly responsive on the control on the slip rate, that is, the traction control.

In addition, according to the present embodiment, when the slip rate control is performed, the reference wheel speed (target reference wheel speed) is independently set for the four wheels, and the target slip rate is also independently set for the four wheels. In this manner, by independently setting at least any one of the reference wheel speed and the target slip rate for the four wheels, road ability and travelling stability like those provided by a directly coupled 4WD vehicle with a center differential that is locked can be secured, and turning performance of the vehicle can be improved.

According to the present embodiment, in the hybrid control unit 20, since both the reference wheel speed and the target slip rate are set for each of the wheels 3a to 3d, the wheel speed and the target slip rate can be accurately controlled for each of the wheels 3a to 3d. Therefore, it becomes possible to precisely control the traction of each of the wheels 3a to 3d and accurately control the behavior of the vehicle 1.

It is noted that only one of reference wheel speed and the target slip rate may be set for each of the wheels 3a to 3d. That is, a common value may be used as the reference wheel speed in the wheels 3a to 3d, and the target slip rate may be set for each of the wheels 3a to 3d, or a common value may be used as the target slip rate in the wheels 3a to 3d, and the reference wheel speed may be set for each of the wheels 3a to 3d.

For example, when a common value is used as the reference wheel speed for the wheels 3a to 3d and the target slip rate is set for each of the wheels 3a to 3d, the target slip rate is changed for each of the wheels 3a to 3d according to a turning condition or a road surface condition.

It is noted that the turning attitude is calculated based on a difference between the target yaw rate and the actual yaw rate due to the steering angle and the vehicle speed. Then, by changing the target slip rate based on the turning attitude, turning promotion or turning suppression of the vehicle is controlled. For example, turning is promoted by setting the slip rate of the rear wheels 3c and 3d to be higher than the slip rate of the front wheels 3a and 3b, and turning is suppressed by setting the slip rate of the front wheels 3a and 3b to be higher than the slip rate of the rear wheels 3c and 3d. Since the target yaw rate is calculated based on at least the steering wheel angle (steering angle), by changing the target yaw rate according to a steering wheel operation by the driver, the target slip rate can be set for each of the wheels 3a to 3d, and it becomes possible for the driver to control the turning promotion or the turning suppression of the vehicle 1. With regards to this change of the target slip rate based on the turning attitude, the target slip rate may be changed based on the target yaw rate.

On the other hand, the road surface condition is calculated based on a difference between a target drive torque and an estimated drive torque. Then, by changing the target slip rate based on the road surface condition, the torque requested by the driver can be secured. With regard to this change of the target slip rate based on the road surface condition, the target slip rate may be changed based on the target drive torque.

Since the target drive torque is set based on at least the accelerator pedal position, when the accelerator depression amount changes, the target slip rate changes. With this configuration, the slip rate of the four wheels can be evened out by operating the accelerator.

In contrast, in a conventional traction control device, for example, a process of suppressing the drive torque (total torque) of the entire vehicle to reduce slipping to stabilize the behavior of the vehicle when the wheels slip or a process of shifting the drive torque among the four wheels to be optimally distributed without changing the total torque of the vehicle to assist behavior stabilization by the driver has been known.

According to the present embodiment, a reduction amount of slipping is controlled by the driver using the accelerator depression amount or the like, and it becomes possible to assist creation of an attitude of the vehicle which meets an intention of the driver.

The description on the embodiments ends here, but modes of the present invention are not limited to the above embodiments. For example, the vehicle 1 according to the above embodiments is a vehicle capable of performing four-wheel drive by two motors including the front motor 4 and the rear motor 6, and evening-out of the left and right slip rate is performed by the control on the front and rear braking devices 30a to 30d on the left and right. In addition to this, in a vehicle in which the left rear wheel 3c and the right rear wheel 3d are individually driven by motors and which includes three travelling drive motors in total together with the front motor 4, evening-out of the left and right slip rate with regard to the front wheels 3a and 3b may be performed by the control on the left front braking device 30a and the right front braking device 30b. When an active yaw control device based on the control by the two motors for driving the rear wheels 3c and 3d are included, in more detail, when the rear control unit 12 or the hybrid control unit 20 includes a yaw control controlling part, the active yaw control device may be used to even out the left and right slip rate. Furthermore, the left and right braking devices 30c and 30d on the side of the rear wheels 3c and 3d may also be used together to even out the left and right slip rate. When the braking devices 30c and 30d of the rear wheels 3c and 3d are electrically-driven brakes, the responsiveness of the brake control improves, so that it becomes possible to perform the responsive traction control.

In addition, according to the above embodiment, the front control unit and the rear control unit are included as the motor control unit, and the front brake control unit and the rear brake control unit are included as the brake control unit, but both units may be provided to each of the motors and the braking devices, or one each of those units may be provided to the vehicle.

In addition, the vehicle 1 according to the above embodiment is a plug-in hybrid vehicle (PHEV) in which the engine 2 is mounted and which is capable of performing external charging and external power supply, but the present invention can also be applied to a hybrid vehicle (HEV) or an electrically-driven vehicle (EV). The present invention can be applied to a vehicle capable of independently driving four wheels or controlling electrically-driven braking.

### EXPLANATION OF REFERENCE SIGNS

1 vehicle
3a, 3b front wheel (running wheel)
3c, 3d rear wheel (running wheel)
4 front motor (first electric motor, driving means)
6 rear motor (second electric motor, driving means)
20 hybrid control unit (main control unit)
10 front control unit (sub control unit)
12 rear control unit (sub control unit)
30a to 30d braking device (braking means)
31 front brake control unit (sub control unit)
32 rear brake control unit (sub control unit)
50 traction control device (travel control device)
52 reference wheel speed calculating part (target reference wheel speed calculating part)
54 target slip rate calculating/distributing part (target slip rate calculating part)
62 slip rate control part (actual slip rate calculating part, slip rate control part)
72 total driving force estimating part (driving force estimating part)
73 target yaw rate calculating part
74 yaw rate sensor (yaw rate detecting part)

1. A travel control device for a vehicle, the vehicle including driving means for driving front and rear wheels on left and right and braking means for independently braking the front and rear wheels on the left and right and being capable of driving and braking the front and rear wheels on the left and right by the driving means and the braking means, the travel control device comprising:
a main control unit that calculates a requested driving force of the vehicle based on a driver request and a vehicle behavior; and
a sub control unit which is provided to each of the driving means and the control means downstream the main control unit and which controls each of the driving means and the control means based on the requested driving force, wherein
the main control unit includes:
a target reference wheel speed calculating part that calculates a target reference wheel speed that is a target rotation speed set as a reference of the wheels; and
a target slip rate calculating part that calculates a target slip rate of the wheels which is set relative to the target reference wheel speed,
the main control unit calculates the requested driving force based on the target slip rate, and
the sub control unit includes:
an actual slip rate calculating part that calculates an actual slip rate of the wheels; and
a slip rate control part that corrects the requested driving force in a manner that the actual slip rate turns to the target slip rate to control the driving means or the braking means.

2. The travel control device for the vehicle according to claim 1, wherein
the target reference wheel speed calculating part calculates the target reference wheel speed for each of the wheels, and
the target slip rate calculating part calculates the target slip rate for each of the wheels.

3. The travel control device for the vehicle according to claim 1, wherein
the target reference wheel speed calculating part calculates the target reference wheel speed to be set as a value common to the front and rear wheels on the left and right, and
the target slip rate calculating part calculates the target slip rate for each of the wheels.

4. The travel control device for the vehicle according to claim 1, wherein
the target reference wheel speed calculating part calculates the target reference wheel speed for each of the wheels, and
the target slip rate calculating part calculates the target slip rate to be set as a value common to the front and rear wheels on the left and right.

5. The travel control device for the vehicle according to claim 2, further comprising:
a target yaw rate calculating part that calculates a target yaw rate of the vehicle based on at least a steering angle of the vehicle; and
a yaw rate detecting part that detects an actual yaw rate of the vehicle, wherein
the target slip rate calculating part changes the target slip rate for each of the wheels based on the target yaw rate or a difference between the target yaw rate and the actual yaw rate.

6. The travel control device for the vehicle according to claim 2, further comprising:
a driving force estimating part that estimates a total driving force of the vehicle, wherein
the target slip rate calculating part changes the target slip rate for each of the wheels based on the requested driving force or a difference between the requested driving force and the total driving force.

7. The travel control device for the vehicle according to claim 1, wherein
the driving means and the braking means include:
a first electric motor that drives the front wheels of the vehicle;
a second electric motor that drives the rear wheels of the vehicle; and
a braking device which is provided to each of the front and rear wheels on the left and right of the vehicle and which is capable of applying a mutually different braking force to each of the wheels.

8. The travel control device for the vehicle according to claim 3, further comprising:
a target yaw rate calculating part that calculates a target yaw rate of the vehicle based on at least a steering angle of the vehicle; and
a yaw rate detecting part that detects an actual yaw rate of the vehicle, wherein
the target slip rate calculating part changes the target slip rate for each of the wheels based on the target yaw rate or a difference between the target yaw rate and the actual yaw rate.

9. The travel control device for the vehicle according to claim 3, further comprising:
a driving force estimating part that estimates a total driving force of the vehicle, wherein
the target slip rate calculating part changes the target slip rate for each of the wheels based on the requested driving force or a difference between the requested driving force and the total driving force.
